(19) United States
(12) Patent Application Publication
(10) Pub. No.: US 2005/0185869 A1
(43) Pub. Date: Aug. 25, 2005

(54) High torque locking collar for a bearing assembly

(76) Inventor: Louis J. Lenick, Mt. Prospect, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/783,778

(22) Filed: Feb. 20, 2004

(51) Int. Cl. F16C 43/00

(52) U.S. Cl. 384/537

(57) ABSTRACT

An annular locking collar for a bearing assembly mounted on a shaft. The locking collar is formed with a gap which is closeable to increase the locking effect of the collar on the bearing assembly. The locking collar includes lugs formed on the annular collar on opposite sides of the gap. Aligned smooth bore fastener passages are formed in the lugs. A headed threaded fastener extends through the fastener passages with the fastener head engaging one of the lugs and a nut threaded on the fastener engaging another of the lugs to close the gap to lock the collar on the bearing assembly.

### BACKGROUND OF THE INVENTION

This invention is directed to an annular locking collar for compressing fingers of a bearing assembly to fasten the bearing assembly to a rotating shaft. As is conventional, an annular locking collar is split with a gap between the facing split ends of the collar. This gap is narrowed by threaded fastener which pulls the split end faces of the collar together. In the conventional locking collar, a threaded machine screw fastens into threads formed in a bore and annular locking collar on one side of the gap with the threaded fastener passing through a smooth bore in the locking collar portion on the opposite side of the gap. An example of such a conventional locking collar tightening arrangement is shown in U.S. Pat. No. 6,036,372 (Okamoto). The teachings of this patent are incorporated herein by reference. The procedure of threading the machine screw into the threaded bore to tighten the locking collar many times bends the machine screw when high torque is applied to the screw. Bending of the machine screw during tightening can result in breaking of the machine screw during the tightening process or during subsequent operation of the shaft on which the bearing assembly has been tightened.

### SUMMARY OF THE INVENTION

My invention resides in an annular locking collar having a gap with integral lugs on opposite sides of the gap in which unthreaded fastener passages extend through the lugs in alignment with each other with the fastener passages having clearance for the threads of a headed fastener so that upon bending of the locking collar as the gap in the locking collar is narrowed during the tightening of the fastener, the fastener is not bent by twisting or movement of the lugs on the locking collar.

Another object of this invention is a split locking collar having integrally formed lugs on opposite sides of the gap forming the split with the lugs formed so as to accept a threaded fastener with a socket type head.

Another object of this invention is a split locking ring with lugs formed on opposite sides of the gap defining the split with the lugs formed to accept a hex head threaded bolt and a socket tightenable nut.

Other objects of the invention will be found in the following specification, claims and drawings.

### BRIEF DESCRIPTION OF THE DRAWINGS

The invention is illustrated more or less diagrammatically in the following drawings wherein.

FIG. 1 is an axial cross-sectional view of the bearing assembly and locking collar of this invention mounted on a shaft shown partially in phantom lines;

FIG. 2 is an end elevational view of the locking collar of FIG. 1 with parts omitted for clarity of illustration and showing one embodiment of a fastener;

FIG. 3 is an enlarged top plan view of the locking collar of FIG. 2;

FIG. 4 is an end view of the locking collar with a modified fastener; and

FIG. 5 is an enlarged top view of the locking collar and fastener of FIG. 4.

### DESCRIPTION OF THE PREFERRED EMBODIMENTS

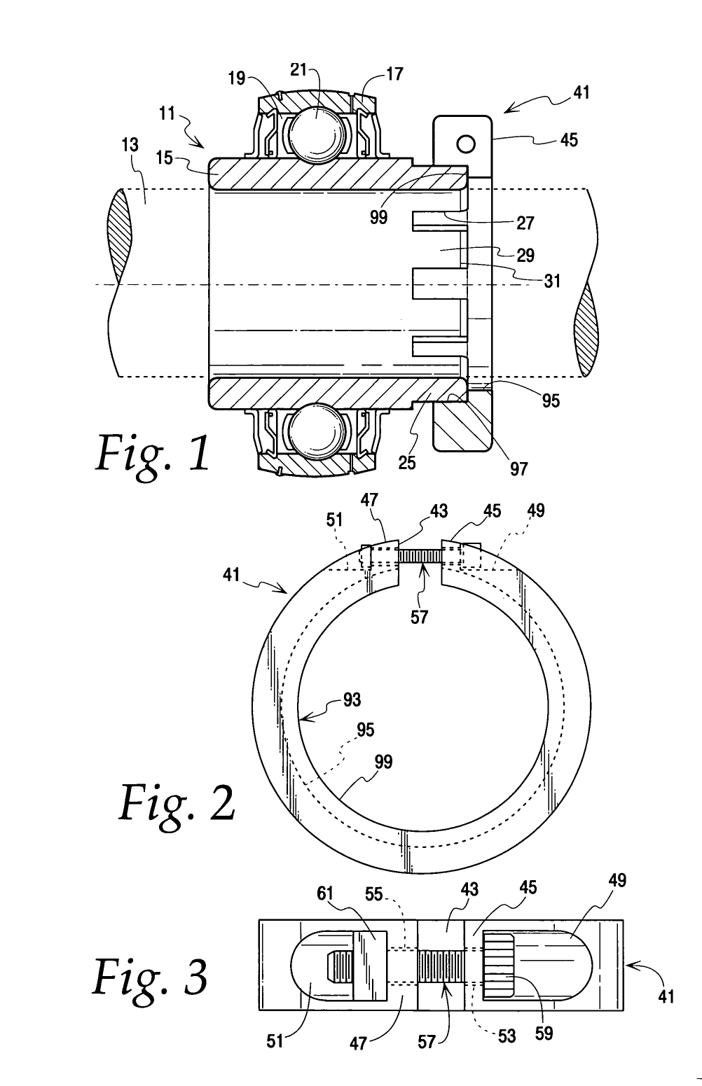

FIG. 1 of the drawings shows a bearing assembly 11 mounted on a shaft 13 which is shown in phantom. The bearing assembly 11 includes an annular inner race member 15 surrounded by an outer race member 17 with an annulus 19 defined between the inner and outer race members. Bearing members, in this case ball bearings 21, ride in grooves formed in both the inner and outer race members. As is conventional, the bearing assembly may include a lubricating passage extending through the outer race member. Inner and outer flingers with annular seals may be prepressed between the inner and outer race members to seal the bearing members 21. However, it should be understood and appreciated that the invention may be applied to other types of bearings which do not have lubricating passages or flingers and seals. The inner race member 15 is formed with an axial extension 25 of reduced thickness. Slots 27 formed in this axial extension define fingers 29 which terminate in distal end walls 31.

To secure the bearing assembly 31 to the rotatable shaft 13, a locking collar 41 is provided. The locking collar fits over the axial extension 25 to force the fingers 29 of the axial extension against the rotatable shaft 13 when the collar is tightened. The locking collar is tightenable because of the formation of a diametrically extending gap 43 therein. Lugs 45 and 47 are formed in the locking collar in the perimeter thereof on opposite sides of the gap. These lugs are defined by grooves 49 and 51 formed in the periphery of the locking collar. A smooth passage 53 is formed in lug 45 in alignment with a smooth passage 55 formed in lug 47 on the opposite side of the gap 43. In this embodiment of the invention, a threaded fastener 57 extends through the aligned smooth passages 53 and 55. The threaded fastener 57 is of the type having a cylindrical head 59 with a socket (not shown) for receiving a wrench or screw driver. With the cylindrical head 59 fitting in the groove 49 in contact with the lug 45, an internally threaded nut, in this case a square head nut 61 fits in groove 51 against lug 47 and is drawn up by the threaded fastener 57 extending therethrough. A suited threaded fastener may be one of the type sold under the trademark “TORX” by Textron, Inc. but it should be understood that other types of fasteners of this design may also be utilized.

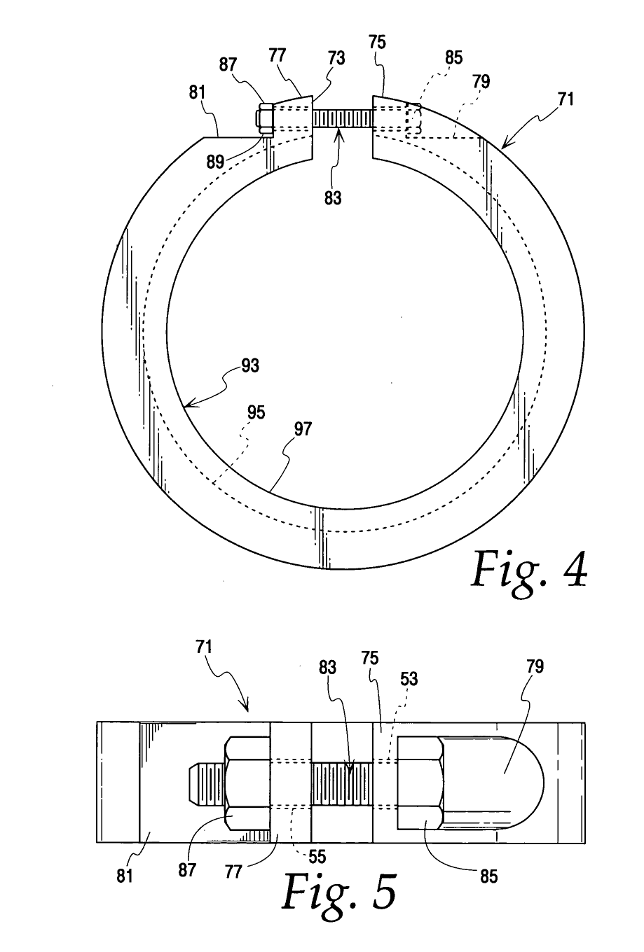

A modified locking collar 71 is shown in FIGS. 4 and 5 of the drawings. It is identical in construction to the locking collar 41 except where otherwise indicated in the following description and drawings. The locking collar 71 is tightenable because of a diametrically extending gap 73 formed therein. Formed on each side of the gap are lugs 75 and 77. Lug 75 is defined by a groove 79 cut in the peripheral surface of the modified locking collar 71 while lug 77 is defined by a chordal notch 81 cut in the outer periphery of the collar 71. A smooth passage 53 extends through the lug 75 to align with a smooth passage 55 extending through the lug 77. A threaded fastener 83 extends through the smooth passages 53 and 55 and this fastener is in the form of a bolt having a hex head 85 which seats in the groove 79 against the lug 75. A hex head nut 87 threads over the end of the threaded fastener at chordal notch 81 which is formed so that there is clearance 89 under the nut so that the nut can be tightened by a wrench.

Both embodiments of the locking collar 41 and 71 are formed with a bore 93 having a larger diameter 95 and a smaller inner diameter 97 separated by an annular radial stop wall 99. The axial length of the larger diameter 95 may be varied to change the amount the locking collar overlies the fingers 29 and thus adjust the area and location of gripping contact between the locking collar and the fingers. It should also be understood and appreciated that the locking collar of this invention may be formed with a single diameter bore or bores with multiple diameter of varying sizes without departing from the scope of the invention.

The use of smooth passages 53 and 55 for the threaded fasteners 57 or 83 permit the application of high torque to the fastener without bending or twisting of the threads of the fastener. Torque is applied to the threaded fastener 57 by use of a screw driver or allen type wrench inserted in the socket of the cylindrical head. This pulls the square head nut 61 against its lug 47 to close the gap 43. In the locking ring 71 shown in FIGS. 4 and 5 of the drawing the gap 73 is reduced by turning the nut 87 with a socket wrench which is not shown. A clearance 89 is provided around and under the nut to allow a socket wrench to be fitted over the nut so a high torque can be applied to the threaded fastener. Since the threaded fastener does not engage smooth walls of the passages 53 and 55, reduction of the gap which brings the lugs 75 and 77 together will not result in bending or twisting of the fastener.

1. An annular locking collar for a bearing assembly mounted on a shaft, said locking collar formed with a gap closeable to increase the locking effect of said collar on said bearing assembly, said locking collar including:
lugs formed on said annular collar on opposite sides of said gap,
aligned smooth bore fastener passages formed in said lugs, and
a headed threaded fastener extending through said fastener passages with said fastener head engaging one of said lugs and a nut threaded on said fastener to engage another of said lugs to close said gap to lock said collar on said bearing assembly.

2. The annular locking collar of claim 1 in which at least one of said lugs is defined by a groove formed in the outer periphery of said annular locking collar.

3. The improved locking collar of claim 1 in which at least one of said lugs is defined by a chordal flat formed on the outer periphery of said annular locking collar.
